(19) United States
(12) Patent Application Publication
(10) Pub. No.: US 2023/0075520 A1
(43) Pub. Date: Mar. 9, 2023

(54) INSULATED GLAZING UNIT INCLUDING AN INTEGRATED ELECTRONICS MODULE

(71) Applicant: SAGE ELECTROCHROMICS, INC., Faribault, MN (US)

(72) Inventors: Bryan D. GREER, Northfield, MN (US); Clifford Lee TAYLOR, Nerstrand, MN (US); Robert J. ANGLEMIER, Waterville, MN (US)

(21) Appl. No.: 17/930,325

(22) Filed: Sep. 7, 2022

Related U.S. Application Data
(60) Provisional application No. 63/241,210, filed on Sep. 7, 2021.

(51) Int. Cl. G02F 1/157; G02F 1/1523; G02F 1/133

(52) U.S. Cl. CPC G02F 1/157; G02F 1/1525; G02F 1/13324

(57) ABSTRACT

A insulated glazing unit is disclosed. The insulated glazing unit can include a first panel, a second panel, an electrochromic device coupled to the first panel, an electronics module coupled to the second panel, and a photovoltaic module coupled to the electronics module, the electrochromic device, and the first panel. In one embodiment, the first panel has a first length and the second panel has a second length, where the second length is less than the first length.

### CROSS-REFERENCE TO RELATED APPLICATION(S)

This application claims priority under 35 U.S.C. § 119(e) to U.S. Provisional Application No. 63/241,210, entitled “INSULATED GLAZING UNIT INCLUDING AN INTEGRATED ELECTRONICS MODULE,” by Bryan D. GREER et al., filed Sep. 7, 2021, which is assigned to the current assignee hereof and incorporated herein by reference in its entirety.

### FIELD OF THE DISCLOSURE

The present disclosure is directed to insulated glazing units that contain electrochromic devices, and more specifically to insulated glazing units and the control modules used in conjunction with the electrochromic devices.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. The optical modulation is the result of the simultaneous insertion and extraction of electrons and charge compensating ions in the electrochemical material lattice.

EC devices have a composite structure through which the transmittance of light can be modulated. A typical layer solid-state electrochromic device in cross-section has the following superimposed layers: a first transparent conductive layer which serves to apply an electrical potential to the electrochromic device, an electrochromic electrode layer which produces a change in absorption or reflection upon oxidation or reduction, an electrolyte layer that allows the passage of ions while blocking electronic current, a counter electrode layer which serves as a storage layer for ions when the device is in the bleached or clear state, and a second transparent conductive layers which also serves to apply an electrical potential to the electrochromic device. EC devices can then be incorporated with various other elements to form an insulated glazing unit, including a control module which is connected to the electrochromic device by wires that run within the frame of the insulated glazing unit. The insulated glazing unit can then be installed within the frame of a window where the wires are out of view.

However, further improvements of insulated glazing units and window designs are desired.

### BRIEF DESCRIPTION OF THE DRAWINGS

Embodiments are illustrated by way of example and are not limited in the accompanying figures.

FIG. 1 is schematic illustration of an insulated glazing unit according to the embodiment of the current disclosure.

FIG. 2 is a schemic cross-section of an improved insulated glazing unit in accordance with an embodiment of the present disclosure.

FIGS. 3A-3B are each a schemic front view illustration of an insulated glazing unit in accordance with the present disclosure.

FIGS. 4A-4B are each a schematic cross-section of an improved insulated glazing unit in accordance with alternative embodiments of the present disclosure.

FIG. 5 is a schematic cross-section of an electrochromic device that can be part of an insulated glazing unit.

Skilled artisans appreciate that elements in the figures are illustrated for simplicity and clarity and have not necessarily been drawn to scale. For example, the dimensions of some of the elements in the figures may be exaggerated relative to other elements to help to improve understanding of the embodiments of the invention.

### DETAILED DESCRIPTION

The following description in combination with the figures is provided to assist in understanding the teachings disclosed herein. The following discussion will focus on specific embodiments and implementations of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or.

The use of “over” is employed to describe elements and components described herein. This description includes variations meant to include layers which are or are not in direct contact with the others.

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

In an embodiment, an electrochromic device can include a substrate, an electrochromic layer, or a counter electrode layer over the substrate, a first transparent conductive layer over the substrate, a second transparent conductive layer, and an adhesion layer disposed between second transparent conductive layer and the counter electrode layer.

In another embodiment, an electrochromic device can include a substrate, an electrochromic layer, or a counter electrode layer over the substrate, a first transparent conductive layer over the substrate, and a second transparent conductive layer in direct contact with the counter electrode layer without any intervening layers.

The incorporation of only a single lithiation step between the counterelectrode and the second transparent conductive layer improves the mechanical strength of the electrochromic device and increases the resistance to mechanical stress.

The embodiments as illustrated in the figures and described below help in understanding particular applications for implementing the concepts as described herein. The embodiments are exemplary and not intended to limit the scope of the appended claims.

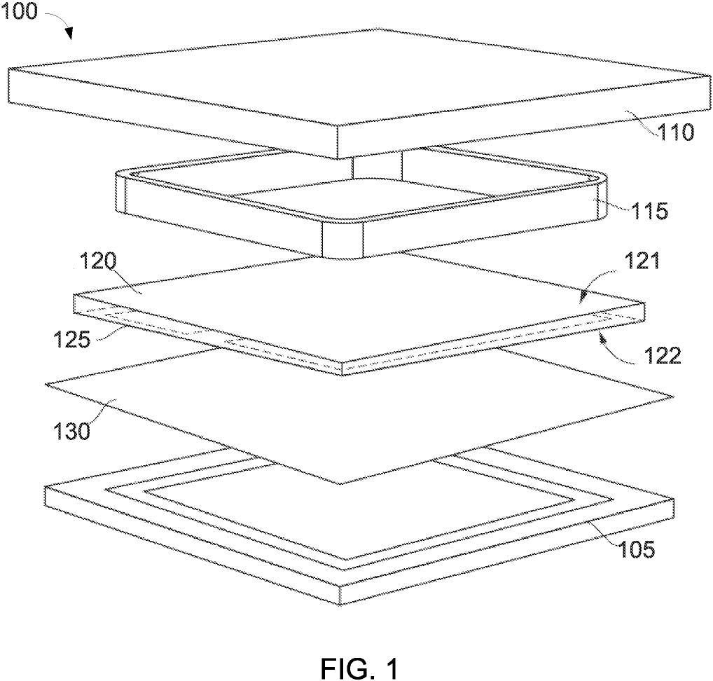

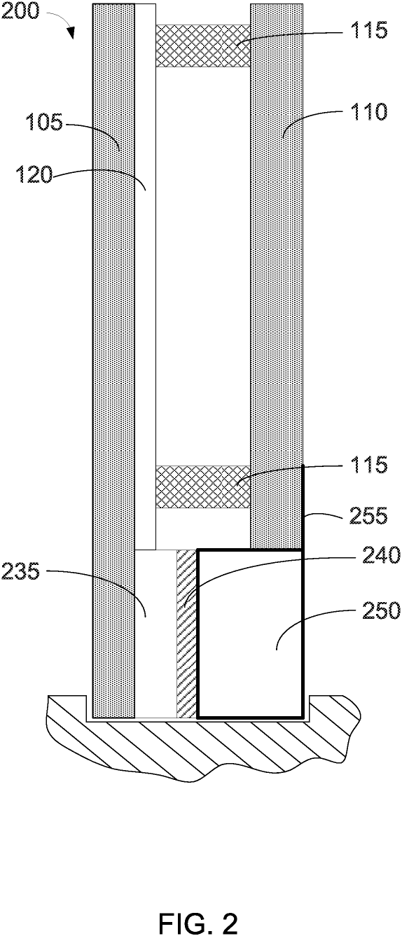

FIG. 1 schematic illustration of an insulated glazing unit 100 according to the embodiment of the current disclosure. The insulated glazing unit 100 can include a first panel 105, an electrochemical device 120 coupled to the first panel 105, a second panel 110, and a spacer 115 between the first panel 105 and second panel 110. As will be discussed below with respect to FIG. 2, the insulated glazing unit 100 can also include an electronics module 218 adjacent to the second panel 110. The first panel 105 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 105 may or may not be flexible. In a particular embodiment, the first panel 105 can be float glass or a borosilicate glass and have a thickness in a range of 2 mm to 20 mm thick. The first panel 105 can be a heat-treated, heat-strengthened, or tempered panel. In one embodiment, the electrochemical device 120 is coupled to first panel 105. In another embodiment, the electrochemical device 120 is on a substrate 125 and the substrate 125 is coupled to the first panel 105. In one embodiment, a lamination interlayer 130 may be disposed between the first panel 105 and the electrochemical device 120. In one embodiment, the lamination interlayer 130 may be disposed between the first panel 105 and the substrate 125 containing the electrochemical device 120. The electrochemical device 120 may be on a first side 121 of the substrate 125 and the lamination interlayer 130 may be coupled to a second side 122 of the substrate 125. The first side 121 may be parallel to and opposite from the second side 122.

The second panel 110 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 110 can be float glass or a borosilicate glass and have a thickness in a range of 5 mm to 30 mm thick. The second panel 110 can be a heat-treated, heat-strengthened, or tempered panel. In one embodiment, the spacer 115 can be between the first panel 105 and the second panel 110. In another embodiment, the spacer 115 is between the substrate 125 and the second panel 110. In yet another embodiment, the spacer 115 is between the electrochemical device 120 and the second panel 110.

In another embodiment, the insulated glazing unit 100 can further include additional layers. The insulated glazing unit 100 can include the first panel 105, the electrochemical device 120 coupled to the first panel 105, the second panel 110, the spacer 115 between the first panel 105 and second panel 110, a third panel, and a second spacer (not shown) between the first panel 105 and the second panel 110. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

FIG. 2 is a schemic cross-section of an improved insulated glazing unit (IGU) 200, in accordance with an embodiment of the present disclosure. The insulated glazing unit 200 can be similar to the insulated glazing unit 100 of FIG. 1 and as such the differences will be discussed in more detail below. The insulated glazing unit 200 can include a first panel 105, a second panel 110, an electrochromic device 120 coupled to the first panel 105, a first spacer 115 between the first panel 105 and second panel 110, a photovoltaic module 235, an insulating material 240, and an electronics module 250. In one embodiment, the second panel 110 has a length that is shorter than a length of the first panel 105. In another embodiment, the second panel 110 has a length that is between 90% and 99% a length of the first panel 105. In another embodiment, the second panel 110 has a length that is between 65% and 90% a length of the first panel 105. In another embodiment, the second panel 110 has a length that is between 1 inch and 6 inches less than a length of the first panel 105.

The insulating material 240 can be between the photovoltaic module 235 and the electronics module 250. In one embodiment, the photovoltaic module 235, the insulating material 240, and the electronics module 250 do not extend past the plane of the length of the first panel 105. In another embodiment, the photovoltaic module 235, the insulating material 240, and the electronics module 250 can be hidden from view on the bottom of the IGU. In another embodiment, the photovoltaic module 235, the insulating material 240, and the electronics module 250 can be hidden from view on a side of the IGU. In yet, another embodiment, the photovoltaic module 235, the insulating material 240, and the electronics module 250 can be hidden from view on the top of the IGU.

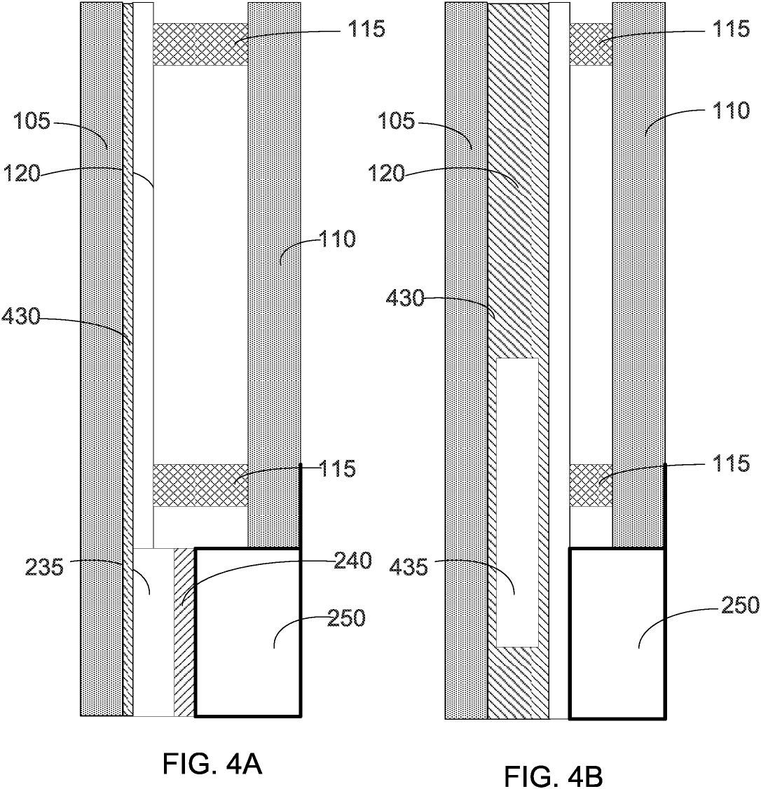

The photovoltaic module 235 can be a solar photovoltaic module. In one embodiment, solar rays can reach the photovoltaic module 235 by passing first through the first panel 105. The photovoltaic module 235 can be between the first panel 105 and the second panel 110. In one embodiment, the photovoltaic module 235 can be coupled to the first panel 105 and coupled to the electrochromic device 120. In another embodiment, the photovoltaic module 235 can be between the first panel 105 and the electronics module 250. In another embodiment, as seen in FIG. 4A, the photovoltaic module 235 can be coupled to the first panel 105 with a lamination interlayer 430. In one embodiment, a first surface of the photovoltaic module 235 can be coupled to the electrochromic device 120 and a second surface of the photovoltaic module 235 can be coupled to the first panel 105, where the first surface is orthogonal to the second surface. By advantageously including a photovoltaic module 235 adjacent to the IGU, the IGU can be self-powered and self-contained. In one embodiment, the photovoltaic module 235 can include a material selected from the group consisting of monocrystalline silicon, polycrystalline silicon, amorphous silicon, gallium arsenide, metal chalcogenides, and organometallics.

The electronics module 250 can include a front face 255 that extends onto a front face of the second panel 110. In one embodiment, the electronics module can be removable. In another embodiment, the electronics module can include an integrated antenna. In one embodiment, the front face 255 can act as an antenna. In one embodiment, the electronics module can be connected to a building management system via a control link. The control link can be a wireless connection. In an embodiment, the control link can use a wireless local area network connection operating according to one or more of the standards within the IEEE 802.11 (WiFi) family of standards, low-power wide-area networks (LPWANs), cell networks, and low-earth orbit (LEO) satellite networks. In one embodiment, a receiver may be located adjacent the IGU. In a particular embodiment, the wireless connections can operate within the 2.4 GHz ISM radio band, within the 5.0 GHz ISM radio band, or a combination thereof. In one embodiment, the electronics module can be electrically connected to controllers via a plurality of sets of frame cables. Each non-light-emitting, variable transmission device can be connected to its corresponding controller via its own frame cable. The building management system can include logic to control the operation of building environmental and facility controls, such as heating, ventilation, and air conditioning (HVAC), lights, scenes for EC devices, including the EC device 120. The logic for the building management systems 110 can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the building management system may include a processor that can execute instructions stored in memory within the building management system or received from an external source.

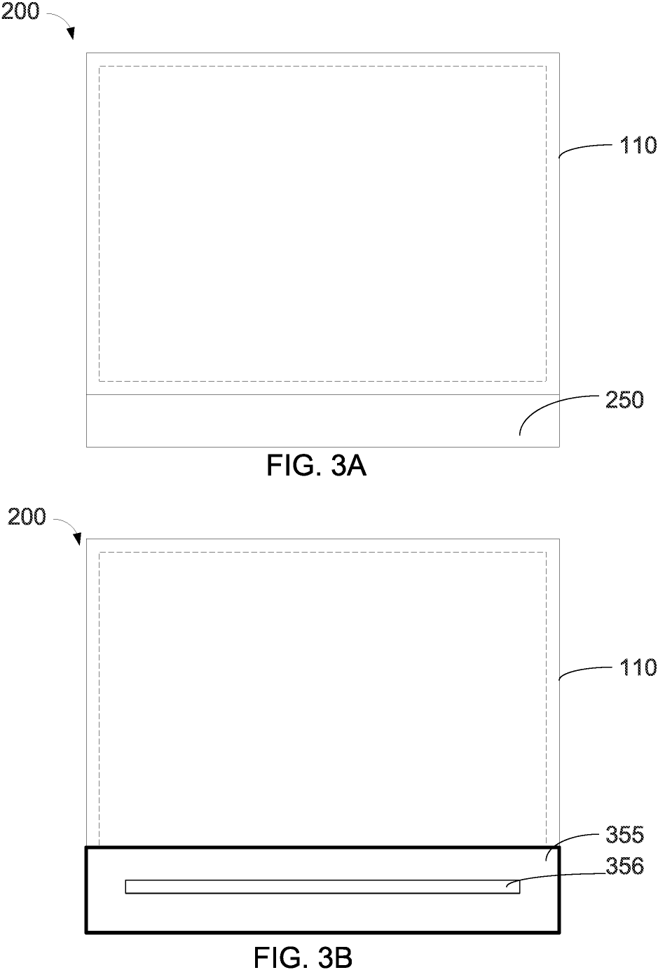

FIGS. 3A-3B are each a schemic front view illustration of an insulated glazing unit in accordance with the present disclosure. As can be seen in FIG. 3A, the electronics module 250 extends the width of the IGU. In one embodiment, as seen in FIG. 3B, the electronics module 250 may include a front cover 355. The second panel 110 can have a geometrically rectangular shape. In one embodiment, the electronics module 250 can extend between 20% and 99% of the width of the IGU. In an embodiment where the electronics module 250 does not extend the entire length of the IGU, a front cover 355 may aesthetically cover the space from view. In another embodiment, the front cover 355 can be removable. In yet another embodiment, a portion, like portion 356 may be removable. By being able to remove a portion 356 of the front cover 255, maintenance may be performed within the electronics module 250 without having to remove the entire electronics module 250. In one embodiment, the front cover 355 can be held in place by a magnetic pull system. In one embodiment, the electronics module 250 does not block or cover the viewable area of the electrochromic device. In another embodiment, the electronics module 250 minimally covers the viewable area of the electrochromic device. For purposes of clarity, minimal coverage can be between 1% and 10%.

FIGS. 4A-4B are each a schematic cross-section of an improved insulated glazing unit in accordance with alternative embodiments of the present disclosure. In one embodiment, as seen in FIG. 4A, the first panel 105 can have a length that extends beyond the bottom plane of the electronics module 250 and photovoltaic module 435. In another embodiment, as seen in FIG. 4B, the photovoltaic module 435 can be between the first panel 105 and the electrochemical device 120. In one embodiment, the photovoltaic module 435 may be within the lamination interlayer 430. In one embodiment, the photovoltaic module 435 may have a length that is between 10% and 40% the length of the first panel 105. In one embodiment, the electronics module 250 may be directly coupled to the electrochemical device 120. In another embodiment, the electronics module 250 may be directly coupled to the photovoltaic module 235.

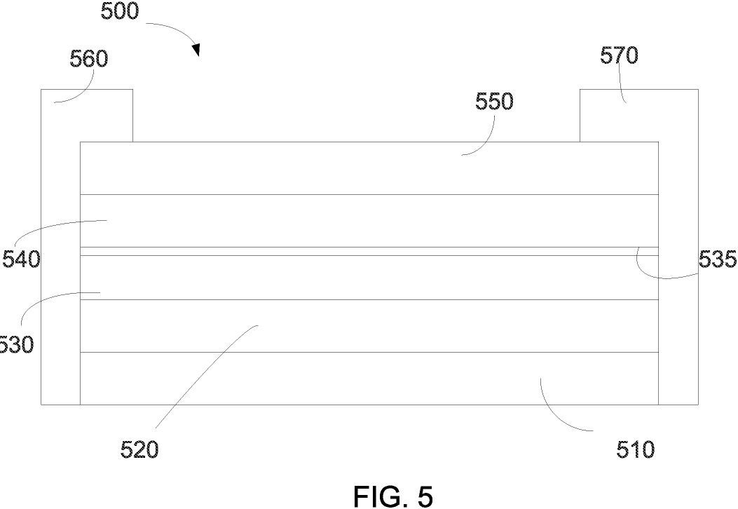

FIG. 5 is a schematic cross-section of an electrochemical device 500 with an improved film structure, in accordance with an embodiment of the present disclosure. The electrochemical device 500 can be used in the IGU of FIGS. 1-4B. For purposes of illustrative clarity, the electrochemical device 500 is a variable transmission device. In one embodiment, the electrochemical device 500 can be an electrochromic device. In another embodiment, the electrochemical device 500 can be a thin-film battery. However, it will be recognized that the present disclosure is similarly applicable to other types of scribed electroactive devices, electrochemical devices, as well as other electrochromic devices with different stacks or film structures (e.g., additional layers). With regard to the electrochemical device 500 of FIG. 5, the device 500 may include a substrate 510, a first transparent conductor layer 520, a cathodic electrochemical layer 530, an anodic electrochemical layer 540, and a second transparent conductor layer 550.

The substrate 510 can include a material selected from the group consisting of a glass substrate, a sapphire substrate, an aluminum oxynitride (A1ON) substrate, a spinel substrate, or a transparent polymer. In another embodiment, the substrate 510 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 510 may or may not be flexible. In a particular embodiment, the substrate 510 can be float glass or a borosilicate glass and have a thickness in a range of 0.5 mm to 12 mm thick. The substrate 510 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm.

In a particular embodiment, the transparent substrate 510 can include ultra-thin glass that is a mineral glass having a thickness in a range of 50 microns to 300 microns. In another embodiment, the laminate can include a solar control layer that reflects ultraviolet radiation or a low emissivity material.

In an embodiment, the transparent substrate 510 can be a glass substrate that can be a mineral glass including SiO₂ and one or more other oxides. Such other oxides can include Al₂O₃, an oxide of an alkali metal, an oxide of an alkaline earth metal, B₂O₃, ZrO₂, P₂O₅, ZnO, SnO₂, SO₃, As₂O₂, or Sb₂O₃. The transparent substrate 510 may include a colorant, such as oxides of iron, vanadium, titanium, chromium, manganese, cobalt, nickel, copper, cerium, neodymium, praseodymium, or erbium, or a metal colloid, such as copper, silver, or gold, or those in an elementary or ionic form, such as selenium or sulfur. In an embodiment in which the transparent substrate 510 is a glass substrate, the glass substrate is at least 50 wt% SiO₂. In some applications, the glass substrate 510 is desired to be clear, and thus, the content of colorants is low. In a particular embodiment, the iron content is less than 200 ppm. In an embodiment, the SiO₂ content is in a range of 50 wt% to 85 wt%. Al₂O₃ may help with scratch resistance, for example, when the major surface is along an exposed surface of the laminate being formed. When present, Al₂O₃ content can be in a range of 1 wt% to 20 wt%.

The glass substrate 510 can include heat-strengthened glass, tempered glass, partially heat-strengthened or tempered glass, or annealed glass. “Heat-strengthened glass” and “tempered glass,” as those terms are known in the art, are both types of glass that have been heat treated to induce surface compression and to otherwise strengthen the glass. Heat-treated glasses are classified as either fully tempered or heat-strengthened. The term “annealed glass” means glass produced without internal strain imparted by heat treatment and subsequent rapid cooling. Thus, annealed glass only excludes heat-strengthened glass or tempered glass. The glass substrate 510 can be laser cut.

Transparent conductive layers 520 and 550 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 520 and 550 can include gold, silver, copper, nickel, aluminum, or any combination thereof. The transparent conductive layers 520 and 550 can include indium oxide, indium tin oxide, doped indium oxide, tin oxide, doped tin oxide, zinc oxide, aluminum zinc oxide, doped zinc oxide, ruthenium oxide, doped ruthenium oxide and any combination thereof. The transparent conductive layers 520 and 550 can have the same or different compositions. The transparent conductive layers 520 and 550 can have a thickness between 10 nm and 600 nm. In one embodiment, the transparent conductive layers 520 and 550 can have a thickness between 200 nm and 500 nm. In one embodiment, the transparent conductive layers 520 and 550 can have a thickness between 320 nm and 460 nm. In one embodiment the first transparent conductive layer 520 can have a thickness between 10 nm and 600 nm. In one embodiment, the second transparent conductive layer 550 can have a thickness between 80 nm and 600 nm. In one embodiment, the transparent conductive layer 120 overlies the substrate 510.

The layers 530 and 540 can be electrode layers, wherein one of the layers may be a cathodic electrochemical layer, and the other of the layers may be an anodic electrochromic layer (also referred to as a counter electrode layer). In one embodiment, the cathodic electrochemical layer 530 can be an electrochromic layer. The cathodic electrochemical layer 530 can include an inorganic metal oxide material, such as WO₃, V₂O₅, MoOs, Nb₂O₅, TiO2, CuO, Ni₂O₃, NiO, Ir₂O₃, Cr₂O₃, Co₂O₃, Mn₂O₃, mixed oxides (e.g., W-Mo oxide, W-V oxide), or any combination thereof and can have a thickness in a range of 40 nm to 600 nm. In one embodiment, the cathodic electrochemical layer 530 can have a thickness between 100 nm to 500 nm. In one embodiment, the cathodic electrochemical layer 530 can have a thickness between 300 nm to 500 nm. The cathodic electrochemical layer 530 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The counter electrode layer 540 can include any of the materials listed with respect to the cathodic electrochromic layer 530 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the counter electrode layer 540 can have a thickness between 150 nm to 300 nm. In one embodiment, the counter electrode layer 540 can have a thickness between 250 nm to 290 nm. In some embodiments, lithium may be inserted into at least one of the first electrode 530 or second electrode 540. In another embodiment, a mobile element may be inserted into both the first electrode 530 and the second electrode 540. The mobile element can migrate to and provide color for either the electrochromic layer 530 or the counter electrode layer 540 as the electrochromic device changes from a clear to tinted state. In one embodiment, the mobile element can be deposited on the first transparent conductive layer 520—prior to any other layer deposition—and then migrate to the first electrode 530. In another embodiment, the mobile element can be deposited after an adhesion layer and migrate to the second electrode 540. The mobile element can include silver, sodium, hydrogen, lithium, or any combination therein.

In another embodiment, a separate lithiation operation, such as sputtering lithium, may be performed. In one embodiment, the lithium may be co-sputtered with the electrochromic layer 530 using a lithium target. In another embodiment, the lithium may be sputtered with the electrochromic layer 530 using a lithium tungsten oxide target. In such a lithiation operation, the thickness of the lithium may be between 1 µg/cm² and 10 µg/cm². In one embodiment, the lithiation operation may be performed before the deposition of the electrochemical layer 530. In another embodiment, the lithation operation may be performed after the deposition of the counter electrode layer 540. For example, a lithium layer may be deposited in between the first transparent conductive layer 520 and the electrochemical layer 530. In another embodiment, a lithium layer can be deposited after the second transparent conductive layer 550. In yet another embodiment, the lithium layer can be deposited in combination with an intermediate layer such that the lithium is not in direct contact with either the electrochemical layer 530 or the counter electrode layer 540. In such an example, the intermediate layer can have a composition that allows the lithium to migrate to and lithiate the electrochemical layer 530 and/or the counter electrode layer 540. In one embodiment, the intermediate layer can be the adhesion layer described below. In another embodiment, the adhesion layer can include a material selected from the group consisting of a silicate, an aluminum silicate, an aluminum borate, a borate, a zirconium silicate, a niobate, a borosilicate, a phosphosilicate, a nitride, an aluminum fluoride, and another suitable ceramic material. In one embodiment, the lithium layer can be between the electrochemical layer 530 and the counter electrode layer 540 without being in direct contact with either the electrochemical layer 530 or the counter electrode layer 540.

An electrolyte layer 535 can be between the electrochromic layer 530 and the counter electrode layer 540. The electrolyte layer 535 includes a solid electrolyte that allows ions to migrate through the electrolyte layer 535 as an electrical field across the electrolyte layer is changed from the high transmission state to the low transmission state, or vice versa. In an embodiment, the electrolyte layer 535 can be a ceramic electrolyte. In another embodiment, the electrolyte layer 535 can include a silicate-based or borate-based material. The electrolyte layer 535 may include a silicate, an aluminum silicate, an aluminum borate, a borate, a zirconium silicate, a niobate, a borosilicate, a phosphosilicate, a nitride, an aluminum fluoride, or another suitable ceramic material. Other suitable ion-conducting materials can be used, such as tantalum pentoxide or a garnet or perovskite material based on a lanthanide-transition metal oxide. In another embodiment, as formed, the electrolyte layer 535 may include mobile ions. Thus, lithium-doped, or lithium-containing compounds of any of the foregoing may be used. Alternatively, a separate lithiation operation, such as sputtering lithium, may be performed. In such a lithiation operation, the thickness of the lithium may be between 1 µg/cm² and 10 µg/ cm². The electrolyte layer 535 may include a plurality of layers having alternating or differing materials, including reaction products between at least one pair of neighboring layers. The thickness of the electrolyte layer 535 can be in a range of 1 nm to 20 nm. The electrolyte layer 535 may have a thickness of no greater than 10 nm, such as no greater than 5 nm, no greater than 4 nm, no greater than 3 nm, no greater than 2 nm, or no greater than 1 nm.

In another embodiment, the device 500 may include a plurality of layers between the substrate 510 and the first transparent conductive layer 520. In one embodiment, an antireflection layer is between the substrate 510 and the first transparent conductive layer 520. The antireflection layer can include SiO₂, NbO₂, and can be a thickness between 20 nm to 100 nm. The device 500 may include at least two bus bars. A bus bar 560 can be electrically connected to the first transparent conductive layer 520 and a bus bar 570 can be electrically connected to the second transparent conductive layer 550.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. An insulated glazing unit, including: a first panel; a second panel; an electrochromic device coupled to the first panel; an electronics module coupled to the second panel; and a photovoltaic module coupled to the electronics module, the electrochromic device, and the first panel.

Embodiment 2. An insulated glazing unit, including: a first panel having a first length; a second panel having a second length, wherein the second length is less than the first length; an electrochromic device coupled to the first panel; and an electronics module coupled to the second panel.

Embodiment 3. An insulated glazing unit, including: a first panel having a first length; a second panel having a second length, wherein the second length is between 60% and 90% of the first length; an electrochromic device coupled to the first panel; an electronics module coupled to the second panel; and a photovoltaic module coupled to the electronics module.

Embodiment 4. The insulated glazing unit of any one of the preceding embodiments, where the electrochromic device, includes: a first transparent conductive layer; a second transparent conductive layer; an electrochromic layer between the first transparent conductive layer and the a second transparent conductive layer; a counter electrode layer between the first transparent conductive layer and the a second transparent conductive layer; and an electrolyte layer between the electrochromic layer and the counter electrode layer.

Embodiment 5. The insulated glazing unit of embodiment 4, where the electrochromic layer includes a material selected from the group consisting of WO₃, V₂O₅, MoOs, Nb₂O₅, TiO₂, CuO, Ni₂O₃, NiO, Ir₂O₃, Cr₂O₃, C_{O2}O₃, Mn₂O₃, mixed oxides (e.g., W-Mo oxide, W-V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 6. The insulated glazing unit of embodiment 4, where the substrate includes a material selected from the group consisting of glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 7. The insulated glazing unit of embodiment 4, where the first transparent conductive layer includes a material selected from the group consisting of indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 8. The insulated glazing unit of embodiment 4, where the second transparent conductive layer includes a material selected from the group consisting of indium oxide, indium tin oxide, doped indium oxide, tin oxide, doped tin oxide, zinc oxide, doped zinc oxide, ruthenium oxide, doped ruthenium oxide and any combination thereof.

Embodiment 9. The insulated glazing unit of embodiment 4, where the anodic electrochemical layer includes an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃,a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 10. The insulated glazing unit of any one of the preceding embodiments, further including an insulating layer between the photovoltaic module and the electronics module.

Embodiment 11. The insulated glazing unit of any one of the preceding embodiments, further including a lamination interlayer between the first panel and the electrochromic device.

Embodiment 12. The insulated glazing unit of embodiment 11, where the photovoltaic module is within interlayer.

Embodiment 13. The insulated glazing unit of any one of the preceding embodiments, where the electronics module further includes a removable front panel.

Embodiment 14. The insulated glazing unit of embodiment 13, where the removable front panel extends into a visible area of the electrochromic device.

Embodiment 15. The insulated glazing unit of any one of the preceding embodiments, where the photovoltaic module is below the electrochromic device.

Embodiment 16. The insulated glazing unit of any one of the preceding embodiments, where the electronics module is coupled to and below the second panel.

Embodiment 17. The insulated glazing unit of any one of the preceding embodiments, where the electrochromic device has a first width, the first panel has a second width.

Embodiment 18. The insulated glazing unit of embodiment 17, where the first width is the same as the second width.

Embodiment 19. The insulated glazing unit of embodiment 17, where the first width is between 50% and 99% the second width.

Embodiment 20. The insulated glazing unit of any one of the preceding embodiments, further including a spacer between the first panel and the second panel.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the embodiments.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An insulated glazing unit, comprising:
a first panel;
a second panel;
an electrochromic device coupled to the first panel;
an electronics module coupled to the second panel; and
a photovoltaic module coupled to the electronics module, the electrochromic device, and
the first panel.

2. The insulated glazing unit of claim 1, wherein the electrochromic device, comprises:
a first transparent conductive layer;
a second transparent conductive layer;
an electrochromic layer between the first transparent conductive layer and the a second transparent conductive layer;
a counter electrode layer between the first transparent conductive layer and the a second transparent conductive layer; and
an electrolyte layer between the electrochromic layer and the counter electrode layer.

3. The insulated glazing unit of claim 2, wherein the electrochromic layer comprises a material selected from the group consisting of WO₃, V₂O₅, MoOs, Nb₂0₅, TiO₂, CuO, Ni₂O₃, NiO, Ir₂03, Cr₂0₃, C_{O2}O₃, Mn₂O₃, mixed oxides (e.g., W-Mo oxide, W-V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

4. The insulated glazing unit of claim 3, wherein the substrate comprises a material selected from the group consisting of glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

5. The insulated glazing unit of claim 2, wherein the first transparent conductive layer comprises a material selected from the group consisting of indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

6. The insulated glazing unit of claim 2, wherein the second transparent conductive layer comprises a material selected from the group consisting of indium oxide, indium tin oxide, doped indium oxide, tin oxide, doped tin oxide, zinc oxide, doped zinc oxide, ruthenium oxide, doped ruthenium oxide and any combination thereof.

7. The insulated glazing unit of claim 2, wherein the anodic electrochemical layer comprises an inorganic metal oxide electrochemically active material, such as WO₃, V₂O₅, MoO₃, Nb₂O₅, TiO₂, CuO, Ir₂0₃, Cr₂0₃, Co₂O₃, Mn₂03, Ta₂O₅, ZrO₂, HfO2, Sb₂O₃,a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

8. The insulated glazing unit of claim 1, further comprising an insulating layer between the photovoltaic module and the electronics module.

9. The insulated glazing unit of claim 1, further comprising a lamination interlayer between the first panel and the electrochromic device.

10. The insulated glazing unit of claim 8, wherein the photovoltaic module is within interlayer.

11. An insulated glazing unit, comprising:
a first panel having a first length;
a second panel having a second length, wherein the second length is less than the first length;
an electrochromic device coupled to the first panel; and
an electronics module coupled to the second panel.

12. The insulated glazing unit of claim 11, wherein the electronics module further comprises a removable front panel.

13. The insulated glazing unit of claim 12, wherein the removable front panel extends into a visible area of the electrochromic device.

14. The insulated glazing unit of claim 11, wherein the photovoltaic module is below the electrochromic device.

15. The insulated glazing unit of claim 11, wherein the electronics module is coupled to and below the second panel.

16. An insulated glazing unit, comprising:
a first panel having a first length;
a second panel having a second length, wherein the second length is between 60% and 90% of the first length;
an electrochromic device coupled to the first panel;
an electronics module coupled to the second panel; and
a photovoltaic module coupled to the electronics module.

17. The insulated glazing unit of claim 16 wherein the electrochromic device has a first width, the first panel has a second width.

18. The insulated glazing unit of claim 17, wherein the first width is the same as the second width.

19. The insulated glazing unit of claim 17, wherein the first width is between 50% and 99% the second width.

20. The insulated glazing unit of claim 17, further comprising a spacer between the first panel and the second panel.
